(19) United States
(12) Patent Application Publication
(10) Pub. No.: US 2022/0380210 A1
(43) Pub. Date: Dec. 1, 2022

(54) SINGLE-OPEN-END TUBULARS AND METHOD OF USE

(71) Applicant: Utility Global, Inc., Houston, TX (US)

(72) Inventors: Nicholas Farandos, Bray (IE); Matthew Dawson, Katy, TX (US); Jin Dawson, Katy, TX (US); Thomas Stilson, Katy, TX (US)

(73) Assignee: Utility Global, Inc., Houston, TX (US)

(21) Appl. No.: 17/825,423

(22) Filed: May 26, 2022

Related U.S. Application Data
(60) Provisional application No. 63/194,412, filed on May 28, 2021.

(51) Int. Cl. C01B 3/16; B01J 23/755; B01J 23/83; B01J 35/06

(52) U.S. Cl. CPC C01B 3/16; B01J 23/755; B01J 23/83; B01J 35/065; B01J 2219/00283; B01J 2219/1943

(57) ABSTRACT

Herein discussed is a tubular comprising: an open end; an opposite closed end; and a mixed conducting membrane in at least a portion of the circumferential surface of the tubular. In an embodiment, the tubular comprises a cathode in contact with one circumferential side of the mixed conducting membrane and an anode in contact with the opposite circumferential side of the mixed conducting membrane. Methods of making and using such a tubular are also discussed herein.

### CROSS-REFERENCE TO RELATED APPLICATIONS

This application claims the benefit under 35 U.S.C. 119(e) of U.S. Provisional Patent Application No. 63/194,412 filed May 28, 2021, the entire disclosure of which is hereby incorporated herein by reference.

### TECHNICAL FIELD

This invention generally relates to tubulars with a single open end. More specifically, this invention relates to tubulars with a single open end for electrochemical reactions.

### BACKGROUND

Tubular reactors have been used in various applications. Typically, a tubular reactor is a vessel, through which continuous flow is passed so that conversion of various chemicals take place. When the flow and the reactions reach steady state, the dependent variables are functions of position in the tubular reactor rather than of time. We have unexpectedly discovered tubulars with a single open end that are suitable for certain reactions that are not fit in traditional tubular reactors. For example, the water-gas shift (WGS) reaction describes the reaction of carbon monoxide and water vapor to form carbon dioxide and hydrogen: CO+H₂O [symbol] CO₂+H₂. The reverse water gas shift (RWGS) reaction is the reaction in the reverse direction, i.e., the reaction of carbon dioxide and hydrogen to form carbon monoxide and water. These two reactions, WGS and RWGS, are in equilibrium.

The WGS equilibrium reactions are in many applications, such as in the production of ammonia, hydrocarbons, methanol, and hydrogen. It is often used in conjunction with steam reforming of methane and other hydrocarbons. In the Fischer-Tropsch process, the WGS equilibrium reaction is one of the most important reactions used to balance the H₂/CO ratio. In addition, WGS equilibrium reactions have been combined with the gasification of coal to produce hydrogen. Hydrogen in large quantities is needed in the petroleum and chemical industries. For example, large amounts of hydrogen are used in upgrading fossil fuels and in the production of ammonia or methanol or hydrochloric acid. Petrochemical plants need hydrogen for hydrocracking, hydrodesulfurization, hydrodealkylation. Hydrogenation processes to increase the level of saturation of unsaturated fats and oils also need hydrogen. Hydrogen is also a reducing agent of metallic ores.

Conventionally, WGS reactions are catalyzed by two categories of catalysts—high temperature shift (HTS) catalyst and low temperature shift (LTS) catalyst. The HTS catalyst consists of iron oxide stabilized by chromium oxide; the LTS catalyst is based on copper. To date, WGS equilibrium reactions have been performed chemically. Contrary to conventional practice, this disclosure discusses an unexpected discovery of WGS reactions performed electrochemically. In particular, this disclosure discusses such electrochemical reactions taking place in tubulars with a single open end.

### SUMMARY

Herein discussed is a tubular comprising: an open end; an opposite closed end; a circumferential surface; and a mixed conducting membrane in at least a portion of the circumferential surface of the tubular. In an embodiment, the tubular comprises a cathode in contact with one circumferential side of the mixed conducting membrane and an anode in contact with the opposite circumferential side of the mixed conducting membrane.

In an embodiment, the anode and the cathode comprise Ni or NiO and a material selected from the group consisting of YSZ, CGO, SDC, SSZ, LSGM, and combinations thereof. In an embodiment, the anode and the cathode comprise metallic phase and ceramic phase, wherein the metallic phase is electronically conductive, and wherein the ceramic phase is ionically conductive. In an embodiment, the anode and the cathode are porous electrodes in a reducing atmosphere. In an embodiment, at least a portion of the closed end is impermeable to fluid flow, wherein said portion remains impermeable in a reducing atmosphere.

In an embodiment, the membrane is impermeable to fluid flow, wherein said membrane remains impermeable in a reducing atmosphere. In an embodiment, the membrane comprises an electronically conducting phase containing doped lanthanum chromite or an electronically conductive metal or combination thereof; and wherein the membrane comprises an ionically conducting phase containing a material selected from the group consisting of gadolinium or samarium doped ceria, yttria-stabilized zirconia (YSZ), lanthanum strontium gallate magnesite (LSGM), scandia-stabilized zirconia (SSZ), Sc and Ce doped zirconia, and combinations thereof. In an embodiment, the doped lanthanum chromite comprises strontium doped lanthanum chromite, iron doped lanthanum chromite, strontium and iron doped lanthanum chromite, lanthanum calcium chromite, or combinations thereof; and wherein the conductive metal comprises Ni, Cu, Ag, Au, Pt, Rh, Co, Ru, or combinations thereof. In an embodiment, the membrane comprises CoCGO or LST (lanthanum-doped strontium titanate)-YSZ or LST-SSZ.

In an embodiment, the tubular comprises a tubular substrate. In an embodiment, the substrate is not the anode, cathode, or mixed conducting membrane. In an embodiment, the substrate comprises zirconia, alumina, NiO, 8YSZ, 3YSZ, 5YSZ, or combinations thereof. In an embodiment, the substrate is porous. In an embodiment, the substrate has a porosity in the range of from about 15% to about 65% or from about 20% to about 50%. In an embodiment, the substrate has a pore size in the range of 10 nm-100 μm, or 50 nm-50 μm, or 1-30 μm, or 0.1-0.2 μm.

In an embodiment, the closed end is an integral part of the tubular. In an embodiment, the closed end is a separate part from the tubular. In an embodiment, the closed end has a thermal expansion coefficient TECe and the tubular has a thermal expansion coefficient TECt, wherein the absolute value of (TECt−TECe) is no greater than 10 ppm/K. In an embodiment, the absolute value of (TECt−TECe) is no greater than 5 ppm/K or no greater than 3 ppm/K or no greater than 2 ppm/K or no greater than 1 ppm/K.

In an embodiment, the closed end and the tubular have a maximum clearance of no greater than 5 mm, or no greater than 2 mm, or no greater than 1 mm, or no greater than 500 μm, or no greater than 200 μm, or no greater than 100 μm, or no greater than 50 μm. In an embodiment, the length of the tubular is no less than 5 cm or no less than 8 cm. In an embodiment, the thickness of the tubular is no greater than 2 mm or no greater than 1 mm.

Also discussed herein is a tubular assembly comprising one or more tubulars with each tubular having an open end, an opposite closed end, a circumferential surface, a mixed conducting membrane in at least a portion of the circumferential surface of the tubular, and an inlet extending toward the closed end of the tubular and ending in proximity to the closed end of the tubular. In an embodiment, the assembly comprises a manifolded connected to the inlets for the tubulars.

Further disclosed herein is a method of making a tubular comprising forming a tubular having an open end; an opposite closed end; a circumferential surface; and a mixed conducting membrane in at least a portion of the circumferential surface of the tubular. In an embodiment, the closed end is a separate part from the tubular. In an embodiment, the closed end and the tubular are in contact with each other such that the closed end does not allow fluid passage.

Further aspects and embodiments are provided in the following drawings, detailed description, and claims. Unless specified otherwise, the features as described herein are combinable and all such combinations are within the scope of this disclosure.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 illustrates an electrochemical (EC) reactor or an electrochemical gas producer, according to an embodiment of this disclosure.

FIG. 2A illustrates a tubular electrochemical reactor, according to an embodiment of this disclosure.

FIG. 2B illustrates a cross section of a tubular electrochemical reactor, according to an embodiment of this disclosure.

FIG. 3A illustrates a tubular comprising an integral closed end and an open end, according to an embodiment of this disclosure.

FIG. 3B illustrates a tubular assembly having a tubular comprising an integral closed end and an open end; and an inlet extending toward the closed end of the tubular, according to an embodiment of this disclosure.

FIG. 4A-4D illustrates tubulars having separate closed ends as discussed herein, according to various embodiments of this disclosure.

### DETAILED DESCRIPTION

### Overview

The disclosure herein describes a tubular with an open end and an opposite closed end. The tubular comprises a mixed conducting membrane in at least a portion of the circumferential surface of the tubular. In some cases, the membrane extends the entire circumferential surface of the tubular, such as the inner surface, the outer surface, or embedded between the inner and outer surfaces (e.g., a middle layer in a sandwich structure). In various embodiments, the circumferential surface of the tubular includes the closed end. In some cases, the closed end is an integral part of the tubular. In some cases, the closed end is a separate part from the tubular. A closed end as used herein refers to any part of assembly of parts to close off one end of the tubular. If the closed end is a separate part, the clearance between the tubular and the closed end is the distance between the adjacent surfaces of the tubular and the closed end.

A mixed conducting membrane is able to transport both electrons and ions. Ionic conductivity includes ionic species such as oxygen ions (or oxide ions), protons, halogenide anions, chalcogenide anions. In various embodiment, the mixed conducting membrane of this disclosure comprises an electronically conducting phase and an ionically conducting phase.

In this disclosure, the cross section of the tubulars is shown to be circular, which is illustrative only and not limiting. The cross section of the tubulars is any suitable shape as known to one skilled in the art, such as square, square with rounded corners, rectangle, rectangle with rounded corners, triangle, hexagon, pentagon, oval, irregular shape, etc.

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like. As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, compositions and materials are used interchangeably unless otherwise specified. Each composition/material may have multiple elements, phases, and components. Heating as used herein refers to actively adding energy to the compositions or materials.

In this disclosure, no substantial amount of H₂ means that the volume content of the hydrogen is no greater than 5%, or no greater than 3%, or no greater than 2%, or no greater than 1%, or no greater than 0.5%, or no greater than 0.1%, or no greater than 0.05%.

As used herein, CGO refers to Gadolinium-Doped Ceria, also known alternatively as gadolinia-doped ceria, gadolinium-doped cerium oxide, cerium(IV) oxide, gadolinium-doped, GDC, or GCO, (formula Gd:CeO2). CGO and GDC are used interchangeably unless otherwise specified. Syngas (i.e., synthesis gas) in this disclosure refers to a mixture consisting primarily of hydrogen, carbon monoxide and carbon dioxide.

As used herein, ceria refers to cerium oxide, also known as ceric oxide, ceric dioxide, or cerium dioxide, is an oxide of the rare-earth metal cerium. Doped ceria refers to ceria doped with other elements, such as samaria-doped ceria (SDC), or gadolinium-doped ceria (GDC or CGO). As used herein, chromite refers to chromium oxides, which includes all the oxidation states of chromium oxides.

A layer or substance being impermeable as used herein refers to it being impermeable to fluid flow. For example, an impermeable layer or substance has a permeability of less than 1 micro darcy, or less than 1 nano darcy.

In this disclosure, sintering refers to a process to form a solid mass of material by heat or pressure, or a combination thereof, without melting the material to the extent of liquefaction. For example, material particles are coalesced into a solid or porous mass by being heated, wherein atoms in the material particles diffuse across the boundaries of the particles, causing the particles to fuse together and form one solid piece.

Related to the electrochemical WGS reactor and methods of use, various components of the reactor are described such as electrodes and membranes along with materials of construction of the components. The following description recites various aspects and embodiments of the inventions disclosed herein. No particular embodiment is intended to define the scope of the invention. Rather, the embodiments provide non-limiting examples of various compositions and methods that are included within the scope of the claimed inventions. The description is to be read from the perspective of one of ordinary skill in the art. Therefore, information that is well-known to the ordinarily skilled artisan is not necessarily included.

Electrochemistry is the branch of physical chemistry concerned with the relationship between electrical potential, as a measurable and quantitative phenomenon, and identifiable chemical change, with either electrical potential as an outcome of a particular chemical change, or vice versa. These reactions involve electrons moving between electrodes via an electronically-conducting phase (typically, but not necessarily, an external electrical circuit), separated by an ionically-conducting and electronically insulating membrane (or ionic species in a solution). When a chemical reaction is effected by a potential difference, as in electrolysis, or if electrical potential results from a chemical reaction as in a battery or fuel cell, it is called an electrochemical reaction. Unlike chemical reactions, in electrochemical reactions electrons (and necessarily resulting ions), are not transferred directly between molecules, but via the aforementioned electronically conducting and ionically conducting circuits, respectively. This phenomenon is what distinguishes an electrochemical reaction from a chemical reaction.

### Single-Open-End Tubulars

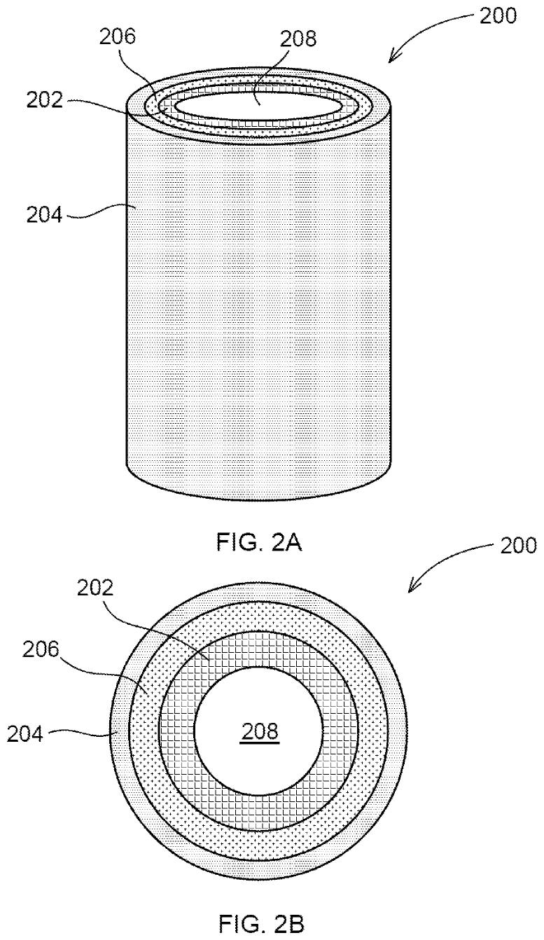

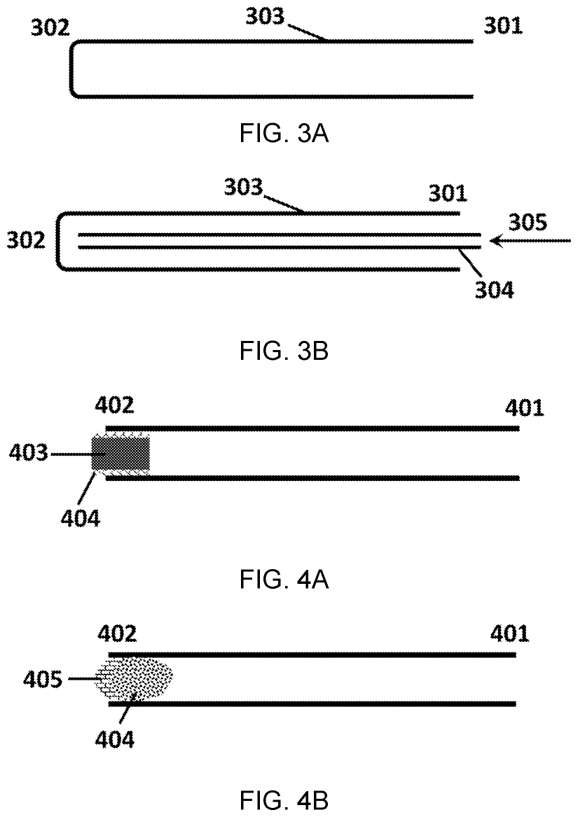

As illustrated in FIG. 3A, a tubular comprises an open end 301, an opposite closed end 302; and a circumferential surface 303, wherein there is a mixed conducting membrane in at least a portion of the circumferential surface of the tubular. Referring to FIGS. 2A and 2B, 202, 204, and 206 each represents a circumferential surface of tubular 200. As illustrated in FIGS. 2A and 2B, these circumferential surfaces are concentric. In other embodiments, the circumferential surfaces are not concentric. In this disclosure, a tubular refers to a tube or a hollow cylinder having a wall. In this disclosure, a circumferential surface of a tubular refers to a surface that surrounds in 360° the centroidal axis of the tubular and is within the wall of the tubular including the wall boundary surfaces.

In an embodiment, the tubular comprises a cathode in contact with one circumferential side of the mixed conducting membrane and an anode in contact with the opposite circumferential side of the mixed conducting membrane. For example, the cathode is on the inner surface of the tubular and the anode is on the outer surface of the tubular. Alternatively, the anode is on the inner surface of the tubular and the cathode is on the outer surface of the tubular. In these examples, the membrane is sandwiched between the anode and the cathode. FIGS. 2A and 2B further illustrate these examples.

In embodiments, the anode and the cathode comprise Ni or NiO and a material selected from the group consisting of YSZ, CGO, SDC, SSZ, LSGM, and combinations thereof. In embodiments, the anode and the cathode comprise metallic phase and ceramic phase, wherein the metallic phase is electronically conductive, and wherein the ceramic phase is ionically conductive. In embodiments, the anode and the cathode are porous electrodes in a reducing atmosphere, e.g., atmospheres containing CO, a hydrocarbon, syngas, H₂, or combinations thereof.

In various embodiments, at least a portion of the closed end is impermeable to fluid flow, wherein said portion remains impermeable in a reducing atmosphere. In various embodiments, the membrane is impermeable to fluid flow, wherein said membrane remains impermeable in a reducing atmosphere. In various embodiments, the membrane comprises an electronically conducting phase containing doped lanthanum chromite or an electronically conductive metal or combination thereof; and wherein the membrane comprises an ionically conducting phase containing a material selected from the group consisting of gadolinium or samarium doped ceria, yttria-stabilized zirconia (YSZ), lanthanum strontium gallate magnesite (LSGM), scandia-stabilized zirconia (SSZ), Sc and Ce doped zirconia, and combinations thereof. In an embodiment, the doped lanthanum chromite comprises strontium doped lanthanum chromite, iron doped lanthanum chromite, strontium and iron doped lanthanum chromite, lanthanum calcium chromite, or combinations thereof; and wherein the conductive metal comprises Ni, Cu, Ag, Au, Pt, Rh, or combinations thereof.

In an embodiment, the tubular comprises a tubular substrate. In an embodiment, the substrate is not the anode, cathode, or mixed conducting membrane. In an embodiment, the substrate comprises zirconia, alumina, NiO, 8YSZ, 3YSZ, 5YSZ, or combinations thereof. In an embodiment, the substrate is porous. In an embodiment, the substrate has a porosity in the range of from about 15% to about 65% or from about 20% to about 50%. In an embodiment, the substrate has a pore size in the range of 10 nm-100 μm, or 50 nm-50 μm, or 1-30 μm, or 0.1-0.2 μm.

In an embodiment, a first electrode material is deposited onto the substrate to form a first electrode layer. In an embodiment, a membrane material is deposited onto the first electrode layer to form the membrane. In an embodiment, a second electrode material is deposited onto the membrane to form a second electrode layer. In an embodiment, said depositing comprises material jetting, binder jetting, inkjet printing, dipping, dip coating, immersion, aerosol jetting, or aerosol jet printing, vat photopolymerization, powder bed fusion, material extrusion, directed energy deposition, sheet lamination, ultrasonic inkjet printing, ultrasonic jetting, ultrasonic spraying, or combinations thereof. In an embodiment, said depositing comprises dip coating, spraying, ultrasonic spraying, spin coating, brush coating, pasting, or combinations thereof. In some cases, deposition takes place on the inside of the tubular. In some cases, deposition takes place on the outside of the tubular. In an embodiment, the substrate is made of the first or second electrode material.

In an embodiment, the first electrode layer, the membrane, and the second electrode layer are sintered separately. In an embodiment, the first electrode layer and the membrane are sintered together; the second electrode layer is sintered separately. In an embodiment, the first electrode layer, the membrane, and the second electrode layer are co-sintered together. In various embodiments, sintering utilizes an electromagnetic radiation (EMR) source or a furnace or combination thereof. In an embodiment, the EMR source and the tubular move relative to each other. In an embodiment, the EMR source is a xenon lamp, or optionally a circular xenon lamp.

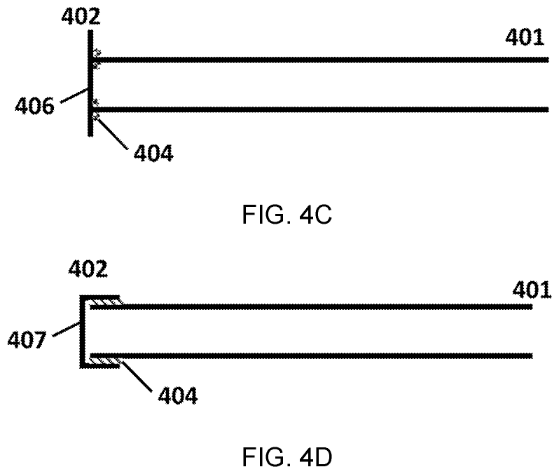

In an embodiment, the closed end is an integral part of the tubular as shown in FIGS. 3A and 3B. In an embodiment, the closed end is a separate part from the tubular as shown in FIG. 4A-4D, wherein 401 represents the open end, 402 represents the closed end. In various embodiments, the closed end and the tubular are in contact with each other such that there is no fluid passage at the closed end. In various embodiments, the closed end and the tubular have a maximum clearance of no greater than 5 mm, or no greater than 2 mm, or no greater than 1 mm, or no greater than 500 μm, or no greater than 200 μm, or no greater than 100 μm, or no greater than 50 μm.

In FIG. 4A, 403 represents a plug that is secured to the inner surface of the tubular via 404, which is an adhesive (e.g., a ceramic adhesive) or a glass seal or combination thereof. In some cases, the combination of a ceramic adhesive and a glass seal refers to a dual functional material that is both a ceramic adhesive and a glass seal. In FIG. 4B, 404 represents a plug that is secured to the inner surface of the tubular, wherein the plug is an adhesive (e.g., a ceramic adhesive). A glass seal 405 is optionally added in addition to the adhesive 404. In some cases, the plug 404 is made of a dual functional material that is both a ceramic adhesive and a glass seal. In FIG. 4C, 406 represents a plate that is secured to the cross-sectional surface of the tubular at the closed end via 404, which represents an adhesive (e.g., a ceramic adhesive) or a glass seal or combination thereof. In FIG. 4D, 407 represents a cap that is secured to the outer surface of the tubular via 404, which is an adhesive (e.g., a ceramic adhesive) or a glass seal or combination thereof.

In various embodiments, the closed end has a thermal expansion coefficient TECe and the tubular has a thermal expansion coefficient TECt, wherein the absolute value of (TECt−TECe) is no greater than 10 ppm/K. In an embodiment, the absolute value of (TECt−TECe) is no greater than 5 ppm/K or no greater than 3 ppm/K or no greater than 2 ppm/K or no greater than 1 ppm/K. In various embodiments, the thermal expansion coefficient of the adhesive or glass seal or combination thereof is TECa, wherein the absolute value of (TECt−TECa) is no greater than 5 ppm/K or no greater than 3 ppm/K or no greater than 2 ppm/K or no greater than 1 ppm/K. The higher the operation temperature for the tubular, the smaller the absolute value of (TECt−TECe) and (TECt−TECa) need to be.

In an embodiment, the length of the tubular is no less than 5 cm or no less than 8 cm or no less than 10 cm or no less than 20 cm or no less than 30 cm or no less than 40 cm or no less than 45 cm. In an embodiment, the thickness of the tubular is no greater than 2 mm or no greater than 1 mm.

As illustrated in FIG. 3B, a tubular assembly is shown having an open end 301, an opposite closed end 302, a mixed conducting membrane in at least a portion of the circumferential surface 303 of the tubular, and an inlet 304 extending toward the closed end of the tubular and ending in proximity to the closed end of the tubular. 305 represents a gas flow into the inlet 304, for example, as feedstock for the tubular reactor. In an embodiment, such an assembly has multiple tubulars with each tubular configured as shown in FIG. 3B. In some cases, the assembly comprises a manifolded connected set of inlets for the tubulars. In some cases, the assembly comprises a manifolded connected to the inlets for the tubulars. In some cases, the assembly comprises a manifolded connecting the inlets for the tubulars.

### Electrochemical Reactor

The tubulars as discussed herein have various applications. This section discusses the use of such tubulars for electrochemical reactions in an electrochemical reactor as an example. Contrary to conventional practice, an electrochemical reactor has been discovered, which comprises an ionically conducting membrane, wherein the reactor is capable of performing the water gas shift reactions electrochemically, wherein electrochemical water gas shift reactions involve the exchange of an ion through the membrane and include forward water gas shift reactions, or reverse water gas shift reactions, or both. This is different from water gas shift reactions via chemical pathways because chemical water gas shift reactions involve direct combination of reactants.

In an embodiment, the reactor comprises porous electrodes that comprise metallic phase and ceramic phase, wherein the metallic phase is electronically conductive and wherein the ceramic phase is ionically conductive. In various embodiments, the electrodes have no current collector attached to them. In various embodiments, the reactor does not contain any current collector. Clearly, such a reactor is fundamentally different from any electrolysis device or fuel cell.

In an embodiment, one of the electrodes in the reactor is an anode that is configured to be exposed to a reducing environment while performing oxidation reactions electrochemically. In various embodiments, the electrodes comprise Ni or NiO and a material selected from the group consisting of YSZ, CGO, SDC, SSZ, LSGM, and combinations thereof.

The electrochemical water gas shift reactions taking place in the reactor comprise electrochemical half-cell reactions, wherein the half-cell reactions are:
a) CO_{(gas)}+O²⁻ [symbol] CO_{2(gas)}+2e⁻
b) H₂O_{(gas)}+2e⁻ [symbol] H_{2(gas)}O²⁻

In various embodiments, the half-cell reactions take place at triple phase boundaries, wherein the triple phase boundaries are the intersections of pores with the electronically conducting phase and the ionically conducting phase. Furthermore, the reactor is also capable of performing chemical water gas shift reactions.

In various embodiments, the ionically conducting membrane conducts protons or oxide ions. In various embodiments, the ionically conducting membrane comprises solid oxide. In various embodiments, the ionically conducting membrane is impermeable to fluid flow. In various embodiments, the ionically conducting membrane also conducts electrons and wherein the reactor comprises no interconnect.

In an embodiment, the membrane comprises an electronically conducting phase containing doped lanthanum chromite or an electronically conductive metal or combination thereof; and wherein the membrane comprises an ionically conducting phase containing a material selected from the group consisting of gadolinium or samarium doped ceria, yttria-stabilized zirconia (YSZ), lanthanum strontium gallate magnesite (LSGM), scandia-stabilized zirconia (SSZ), Sc and Ce doped zirconia, and combinations thereof. In an embodiment, the doped lanthanum chromite comprises strontium doped lanthanum chromite, iron doped lanthanum chromite, strontium and iron doped lanthanum chromite, lanthanum calcium chromite, or combinations thereof; and wherein the conductive metal comprises Ni, Cu, Ag, Au, Pt, Rh, Co, Ru, or combinations thereof.

In an embodiment, the membrane comprises cobalt-CGO (CoCGO). In an embodiment, the membrane consists essentially of CoCGO. In an embodiment, the membrane consists of CoCGO. In an embodiment, the membrane comprises LST (lanthanum-doped strontium titanate)-YSZ or LST-SSZ. In an embodiment, the membrane consists essentially of LST-YSZ or LST-SSZ. In an embodiment, the membrane consists of LST-YSZ or LST-SSZ. In this disclosure, LST-YSZ refers to a composite of LST and YSZ. In various embodiments, the LST phase and the YSZ phase percolate each other. In this disclosure, LST-SSZ refers to a composite of LST and SSZ. In various embodiments, the LST phase and the SSZ phase percolate each other.

Also discussed herein is a reactor comprising a bi-functional layer and a mixed conducting membrane; wherein the bi-functional layer and the mixed conducting membrane are in contact with each other, and wherein the bi-functional layer catalyzes reverse-water-gas-shift (RWGS) reaction and functions as an anode in an electrochemical reaction. In an embodiment, the bi-functional layer as the anode is exposed to a reducing environment and the electrochemical reaction taking place in the bi-functional layer is oxidation. In an embodiment, no current collector is attached to the bi-functional layer. In an embodiment, the bi-functional layer comprises Ni or NiO and a material selected from the group consisting of YSZ, CGO, SDC, SSZ, LSGM, and combinations thereof.

In an embodiment, the membrane comprises an electronically conducting phase containing doped lanthanum chromite or an electronically conductive metal or combination thereof; and wherein the membrane comprises an ionically conducting phase containing a material selected from the group consisting of gadolinium or samarium doped ceria, yttria-stabilized zirconia (YSZ), lanthanum strontium gallate magnesite (LSGM), scandia-stabilized zirconia (SSZ), Sc and Ce doped zirconia, and combinations thereof. In an embodiment, the doped lanthanum chromite comprises strontium doped lanthanum chromite, iron doped lanthanum chromite, strontium and iron doped lanthanum chromite, lanthanum calcium chromite, or combinations thereof; and wherein the conductive metal comprises Ni, Cu, Ag, Au, Pt, Rh, Co, Ru, or combinations thereof.

In an embodiment, the membrane comprises cobalt-CGO (CoCGO). In an embodiment, the membrane consists essentially of CoCGO. In an embodiment, the membrane consists of CoCGO. In an embodiment, the membrane comprises LST (lanthanum-doped strontium titanate)-YSZ or LST-SSZ. In an embodiment, the membrane consists essentially of LST-YSZ or LST-SSZ. In an embodiment, the membrane consists of LST-YSZ or LST-SSZ.

Such a reactor has various applications. In an embodiment, the reactor is utilized to produce carbon monoxide via hydrogenation of carbon dioxide. In another embodiment, the reactor is used to adjust syngas composition (i.e., H₂/CO ratio) by converting H₂ to CO or converting CO to H₂. The discussion herein takes hydrogen production as an example, but the application of the reactor is not limited to only hydrogen production.

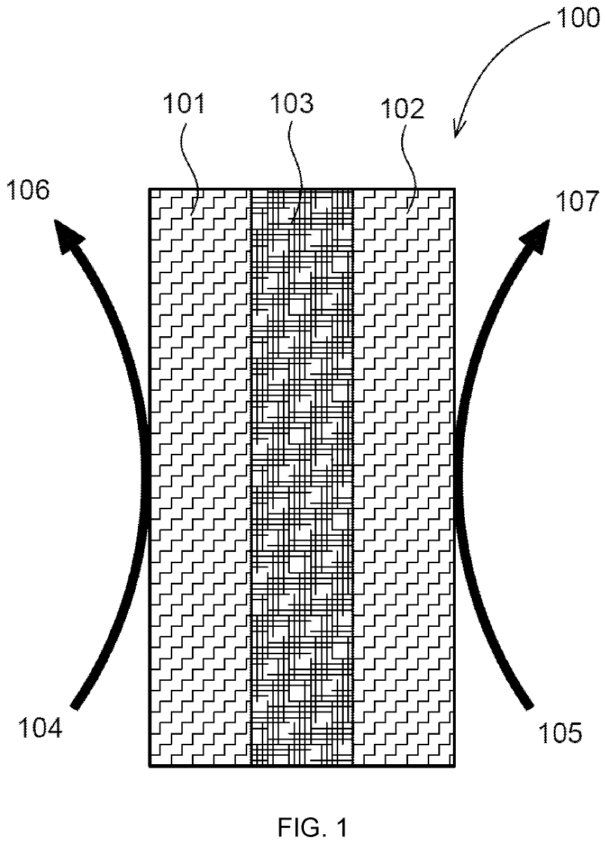

FIG. 1 illustrates an electrochemical reactor or an electrochemical (EC) gas producer 100, according to an embodiment of this disclosure. EC gas producer device 100 comprises first electrode 101, membrane 103 a second electrode 102. First electrode 101 (also referred to as anode or bi-functional layer) is configured to receive a fuel 104. Stream 104 contains no oxygen. Second electrode 102 is configured to receive water (e.g., steam) as denoted by 105.

In an embodiment, device 100 is configured to receive CO, i.e., carbon monoxide (104) and to generate CO/CO₂ (106) at the first electrode (101); device 100 is also configured to receive water or steam (105) and to generate hydrogen (107) at the second electrode (102). In some cases, the second electrode receives a mixture of steam and hydrogen. Since water provides the oxide ion (which is transported through the membrane) needed to oxidize the CO at the opposite electrode, water is considered the oxidant in this scenario. As such, the first electrode 101 is performing oxidation reactions in a reducing environment. In various embodiments, 103 represents an oxide ion conducting membrane. In an embodiment, the first electrode 101 and the second electrode 102 may comprise Ni-YSZ or NiO-YSZ. In an embodiment, the oxide ion conducting membrane 103 also conducts electrons.

In an embodiment, device 100 is configured to simultaneously produce hydrogen 107 from the second electrode 102 and syngas 106 from the first electrode 101. In an embodiment, 104 represents methane and water or methane and carbon dioxide entering device 100. In other embodiments, 103 represents an oxide ion conducting membrane. In an embodiment, first electrode 101 and second electrode 102 may comprise Ni-YSZ or NiO-YSZ. Arrow 104 represents an influx of hydrocarbon and water or hydrocarbon and carbon dioxide. Arrow 105 represents an influx of water or water and hydrogen. In some embodiments, electrode 101 comprises Cu-CGO, or further optionally comprises CuO or Cu₂O or combination thereof. Electrode 102 comprises Ni-YSZ or NiO-YSZ. Arrow 104 represents an influx of hydrocarbon with little to no water, with no carbon dioxide, and with no oxygen, and 105 represents an influx of water or water and hydrogen. Since water provides the oxide ion (which is transported through the membrane) needed to oxidize the hydrocarbon/fuel at the opposite electrode, water is considered the oxidant in this scenario.

In this disclosure, no oxygen means there is no oxygen present at first electrode 101 or at least not enough oxygen that would interfere with the reaction. Also, in this disclosure, water only means that the intended feedstock is water and does not exclude trace elements or inherent components in water. For example, water containing salts or ions is considered to be within the scope of water only. Water only also does not require 100% pure water but includes this embodiment. In embodiments, the hydrogen produced from second electrode 102 is pure hydrogen, which means that in the produced gas phase from the second electrode, hydrogen is the main component. In some cases, the hydrogen content is no less than 99.5%. In some cases, the hydrogen content is no less than 99.9%. In some cases, the hydrogen produced from the second electrode is the same purity as that produced from electrolysis of water.

In an embodiment, first electrode 101 is configured to receive methane and water or methane and carbon dioxide. In an embodiment, the fuel comprises a hydrocarbon having a carbon number in the range of 1-12, 1-10 or 1-8. Most preferably, the fuel is methane or natural gas, which is predominantly methane. In an embodiment, the device does not generate electricity and is not a fuel cell.

In various embodiments, the device does not contain a current collector. In an embodiment, the device comprises no interconnect. There is no need for electricity and such a device is not an electrolyser. The membrane 103 is configured to conduct electrons and as such is mixed conducting, i.e., both electronically conductive and ionically conductive. In an embodiment, the membrane 103 conducts oxide ions and electrons. In an embodiment, the electrodes 101, 102 and the membrane 103 are tubular (see, e.g., FIGS. 2A and 2B). In an embodiment, the electrodes 101, 102 and the membrane 103 are planar. In these embodiments, the electrochemical reactions at the anode and the cathode are spontaneous without the need to apply potential/electricity to the reactor.

In an embodiment, the electrochemical reactor (or EC gas producer) is a device comprising a first electrode, a second electrode, and a membrane between the electrodes, wherein the first electrode and the second electrode comprise a metallic phase that does not contain a platinum group metal when the device is in use, and wherein the membrane is oxide ion conducting. In an embodiment, wherein the first electrode comprises Ni or NiO and a material selected from the group consisting of YSZ, CGO, samaria-doped ceria (SDC), scandia-stabilized zirconia (SSZ), LSGM, and combinations thereof. In an embodiment, the first electrode is configured to receive a fuel. In an embodiment, said fuel comprises a hydrocarbon or hydrogen or carbon monoxide or combinations thereof.

In an embodiment, the second electrode comprises Ni or NiO and a material selected from the group consisting of yttria-stabilized zirconia (YSZ), ceria gadolinium oxide (CGO), samaria-doped ceria (SDC), scandia-stabilized zirconia (SSZ), lanthanum strontium gallate magnesite (LSGM), and combinations thereof. In an embodiment, the second electrode is configured to receive water and hydrogen and configured to reduce the water to hydrogen. In various embodiments, such reduction takes place electrochemically.

In an embodiment, the membrane comprises an electronically conducting phase containing doped lanthanum chromite or an electronically conductive metal or combination thereof; and wherein the membrane comprises an ionically conducting phase containing a material selected from the group consisting of gadolinium or samarium doped ceria, yttria-stabilized zirconia (YSZ), lanthanum strontium gallate magnesite (LSGM), scandia-stabilized zirconia (SSZ), Sc and Ce doped zirconia, and combinations thereof. In an embodiment, the doped lanthanum chromite comprises strontium doped lanthanum chromite, iron doped lanthanum chromite, strontium and iron doped lanthanum chromite, lanthanum calcium chromite, or combinations thereof; and wherein the conductive metal comprises Ni, Cu, Ag, Au, Pt, Rh, Co, Ru, or combinations thereof.

In an embodiment, the membrane comprises cobalt-CGO (CoCGO). In an embodiment, the membrane consists essentially of CoCGO. In an embodiment, the membrane consists of CoCGO. In an embodiment, the membrane comprises LST (lanthanum-doped strontium titanate)-YSZ or LST-SSZ. In an embodiment, the membrane consists essentially of LST-YSZ or LST-SSZ. In an embodiment, the membrane consists of LST-YSZ or LST-SSZ.

FIG. 2A illustrates (not to scale) a tubular electrochemical (EC) reactor or an EC gas producer 200, according to an embodiment of this disclosure. Tubular producer 200 includes an inner tubular structure 202, an outer tubular structure 204, and a membrane 206 disposed between the inner and outer tubular structures 202, 204, respectively. Tubular producer 200 further includes a void space 208 for fluid passage. FIG. 2B illustrates (not to scale) a cross section of a tubular producer 200, according to an embodiment of this disclosure. Tubular producer 200 includes a first inner tubular structure 202, a second outer tubular structure 204, and a membrane 206 between the inner and outer tubular structures 202, 204. Tubular producer 200 further includes a void space 208 for fluid passage.

In an embodiment, the electrodes and the membrane are tubular with the first electrode being outermost and the second electrode being innermost, wherein the second electrode is configured to receive water and hydrogen. In an embodiment, the electrodes and the membrane are tubular with the first electrode being innermost and the second electrode being outermost, wherein the second electrode is configured to receive water and hydrogen. In an embodiment, the electrodes and the membrane are tubular, wherein the first and second electrodes comprise Ni-YSZ or NiO-YSZ.

In an embodiment, the reactor comprises a catalyst that promotes chemical reverse water gas shift (RWGS) reactions. In an embodiment, the catalyst is a high temperature RWGS catalyst. In an embodiment, the catalyst is part of an anode in the reactor. In an embodiment, the catalyst is configured to be outside of the anode. For example, Ni—Al₂O₃ pellets as such a catalyst are placed in the reactor surrounding the tubes as shown in FIG. 2A and FIG. 2B. In an embodiment, the catalyst comprises Ni, Cu, Fe, Pt-group metals, or combinations thereof. In an embodiment, the catalyst comprises Pt, Cu, Rh, Ru, Fe, Ni, or combinations thereof.

It is to be understood that this disclosure describes exemplary embodiments for implementing different features, structures, or functions of the invention. Exemplary embodiments of components, arrangements, and configurations are described to simplify the present disclosure; however, these exemplary embodiments are provided merely as examples and are not intended to limit the scope of the invention. The embodiments as presented herein may be combined unless otherwise specified. Such combinations do not depart from the scope of the disclosure.

Additionally, certain terms are used throughout the description and claims to refer to particular components or steps. As one skilled in the art appreciates, various entities may refer to the same component or process step by different names, and as such, the naming convention for the elements described herein is not intended to limit the scope of the invention. Further, the terms and naming convention used herein are not intended to distinguish between components, features, and/or steps that differ in name but not in function.

While the disclosure is susceptible to various modifications and alternative forms, specific embodiments thereof are shown by way of example in the drawings and description. It should be understood, however, that the drawings and detailed description are not intended to limit the disclosure to the particular form disclosed, but on the contrary, the intention is to cover all modifications, equivalents and alternatives falling within the spirit and scope of this disclosure.

What is claimed is:

1. A tubular comprising:
an open end;
an opposite closed end;
a circumferential surface; and
a mixed conducting membrane in at least a portion of the circumferential surface of the tubular.

2. The tubular of claim 1 comprising a cathode in contact with one circumferential side of the mixed conducting membrane and an anode in contact with the opposite circumferential side of the mixed conducting membrane.

3. The tubular of claim 2, wherein the anode and the cathode comprise Ni or NiO and a material selected from the group consisting of YSZ, CGO, SDC, SSZ, LSGM, and combinations thereof.

4. The tubular of claim 2, wherein the anode and the cathode comprise metallic phase and ceramic phase, wherein the metallic phase is electronically conductive, and wherein the ceramic phase is ionically conductive.

5. The tubular of claim 2, wherein the anode and the cathode are porous electrodes in a reducing atmosphere.

6. The tubular of claim 1, wherein at least a portion of the closed end is impermeable to fluid flow, wherein said portion remains impermeable in a reducing atmosphere.

7. The tubular of claim 1, wherein the membrane is impermeable to fluid flow, wherein said membrane remains impermeable in a reducing atmosphere.

8. The tubular of claim 1, wherein the membrane comprises an electronically conducting phase containing doped lanthanum chromite or an electronically conductive metal or combination thereof; and wherein the membrane comprises an ionically conducting phase containing a material selected from the group consisting of gadolinium or samarium doped ceria, yttria-stabilized zirconia (YSZ), lanthanum strontium gallate magnesite (LSGM), scandia-stabilized zirconia (SSZ), Sc and Ce doped zirconia, and combinations thereof.

9. The tubular of claim 8, wherein the doped lanthanum chromite comprises strontium doped lanthanum chromite, iron doped lanthanum chromite, strontium and iron doped lanthanum chromite, lanthanum calcium chromite, or combinations thereof; and wherein the conductive metal comprises Ni, Cu, Ag, Au, Pt, Rh, Co, Ru, or combinations thereof.

10. The tubular of claim 1, wherein the membrane comprises CoCGO or LST (lanthanum-doped strontium titanate)-YSZ or LST-SSZ.

11. The tubular of claim 1 comprising a tubular substrate, wherein the substrate is not the anode, cathode, or mixed conducting membrane.

12. The tubular of claim 11, wherein the substrate comprises zirconia, alumina, NiO, 8YSZ, 3YSZ, 5YSZ, or combinations thereof.

13. The tubular of claim 1, wherein the closed end is an integral part of the tubular.

14. The tubular of claim 1, wherein the closed end is a separate part from the tubular.

15. The tubular of claim 14, wherein the closed end has a thermal expansion coefficient TECe and the tubular has a thermal expansion coefficient TECt, wherein the absolute value of (TECt−TECe) is no greater than 10 ppm/K.

16. A tubular assembly comprising one or more tubulars with each tubular having
an open end, an opposite closed end, a circumferential surface,
a mixed conducting membrane in at least a portion of the circumferential surface of the tubular, and
an inlet extending toward the closed end of the tubular and ending in proximity to the closed end of the tubular.

17. The assembly of claim 16 comprising a manifolded connected to the inlets for the tubulars.

18. A method of making a tubular comprising
forming a tubular having an open end; an opposite closed end; a circumferential surface; and a mixed conducting membrane in at least a portion of the circumferential surface of the tubular.

19. The method of claim 18, wherein the closed end is a separate part from the tubular.

20. The method of claim 18, wherein the closed end and the tubular are in contact with each other such that the closed end does not allow fluid passage.
